(19) United States
(12) Patent Application Publication
(10) Pub. No.: US 2003/0159361 A1
(43) Pub. Date: Aug. 28, 2003

(54) Reinforced door jamb

(76) Inventor: Noubar Yeremian, Radnor, PA (US)

Correspondence Address: RATNERPRESTIA, P O BOX 980, VALLEY FORGE, PA, 19482-0980, US

(21) Appl. No.: 10/154,998

(22) Filed: May 23, 2002

Related U.S. Application Data
(60) Provisional application No. 60/359,143, filed on Feb. 22, 2002.

(51) Int. Cl. E06B 1/04

(52) U.S. Cl. 49/504

(57) ABSTRACT

A reinforced door jamb is provided. The reinforced door jamb comprises a security plate that is interconnected with hardware (latch plate, lock plate, and hinges) on the front face of the door jamb for securing the door. The interconnected security plate provides greater shear strength and enhances security of the door when an attempt is made to force the door. In an exemplary embodiment, the security plate comprises a lip extending into a groove formed in the back face of the door jamb.

### TECHNICAL FIELD

This invention relates to generally to a reinforced door jamb, and more particularly to a method and apparatus for providing a door jamb with a security plate that provides enhanced security.

### BACKGROUND OF THE INVENTION

A door jamb is fastened to the frame of a commercial or residential structure to support a door and associated locks. Door jambs are typically made of wood and are fastened to the structure frame with nails or screws. Door jambs typically extend around the top and two sides of a door opening and have an inwardly facing or front face with a stepped configuration such that the edges of a closed door abut the step. Hinges are fastened to the front face on one side of the door jamb (the hinge side) and to one side of the door, typically by wood screws that are screwed into the door jamb and door, such that they are not accessible from the outside of the door when the door is closed. A door latch and dead-bolt lock are typically installed on the side of the door opposite the hinges. A latch plate and lock plate are fastened to the front face on the side of the door jamb adjacent the latch and lock (the lock side), typically with wood screws that are screwed into the door jamb.

Although the hinges, latch plate, and lock plate are not accessible from outside of the closed door, the door can be forced open by applying a concentrated force to the door (kicking-in the door). The force can split the wooden door jamb around the lock plate and latch plate. If the dead-bolt is not secured, such as when the structure is not occupied, the jamb need only be split around the latch to compromise the security of the door.

Several door manufacturers provide a flat security plate fastened to the back face of the lock-side door jamb with an opening to engage the dead-bolt for added security. These security plates are fastened to the door jamb by wood screws positioned such that they do not interfere with the wood screws securing the lock plate from the opposite face of the door. The flat plate, however, is only secured by four wood screws and about one half-inch of the door jamb that is located between the dead bolt and the inside edge of the door jamb. Also, the flat plate does not enhance the security of the door when the dead-bolt is not engaged or when the hinge side of the door is kicked in.

To overcome the shortcomings of these security doors, a new door jamb provides greater security than existing security plates, even when the dead-bolt is not engaged. The new door jamb provides enhanced security on both the lock side and the hinge side.

### SUMMARY OF THE INVENTION

To meet these and other needs, and in view of its purposes, an exemplary embodiment of the present invention provides a reinforced door jamb comprising a security plate with a lip extending into a groove formed in the back face of the door jamb. The security plate is interconnected with hardware (latch plate, lock plate, and hinges) on the front face of the door jamb that secure the door, providing greater shear strength and enhancing security of the door when an attempt is made to force the door.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a hinge side of a reinforced door jamb according to an exemplary embodiment of the present invention;

FIG. 2 is a latch side of a reinforced door jamb according to an exemplary embodiment of the present invention;

FIG. 3 is a sectional view of the hinge side of a reinforced door jamb taken along axis 3-3 shown in FIG. 1; and

FIG. 4 is a sectional view of the latch side of a reinforced door jamb taken along axis 4-4 shown in FIG. 2.

### DETAILED DESCRIPTION OF THE INVENTION

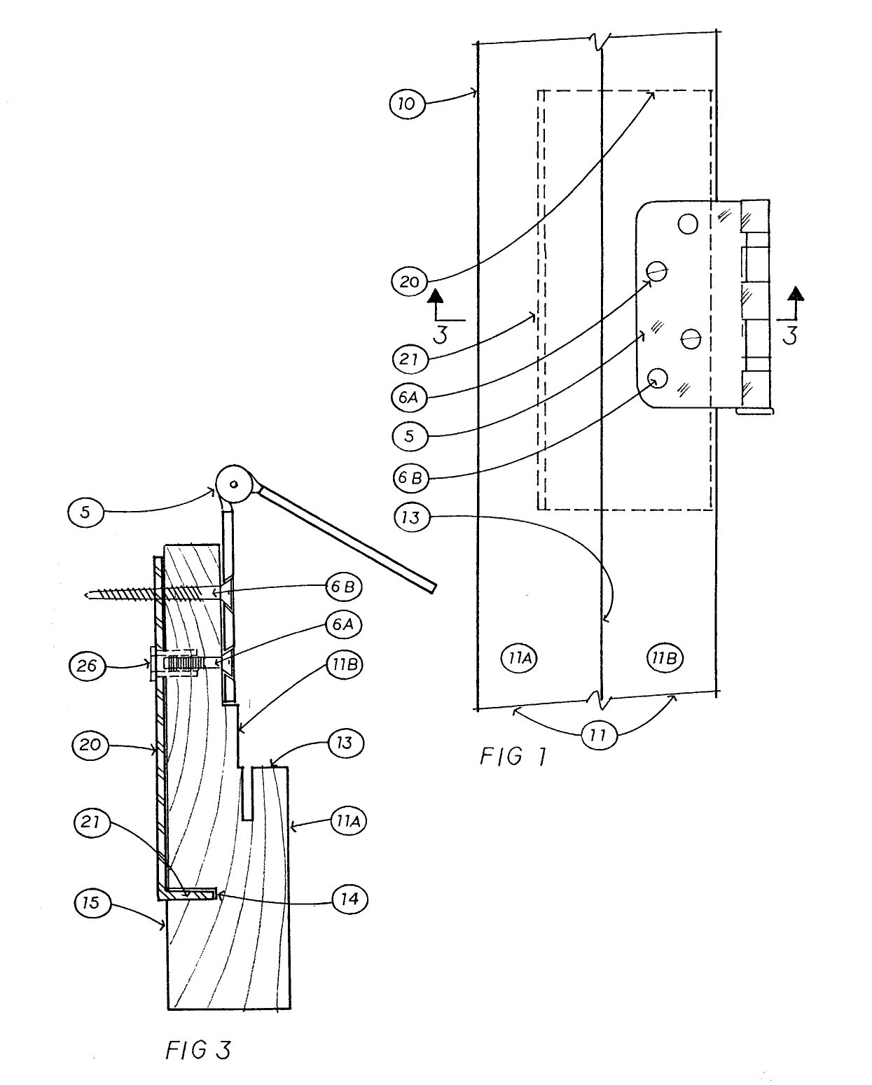

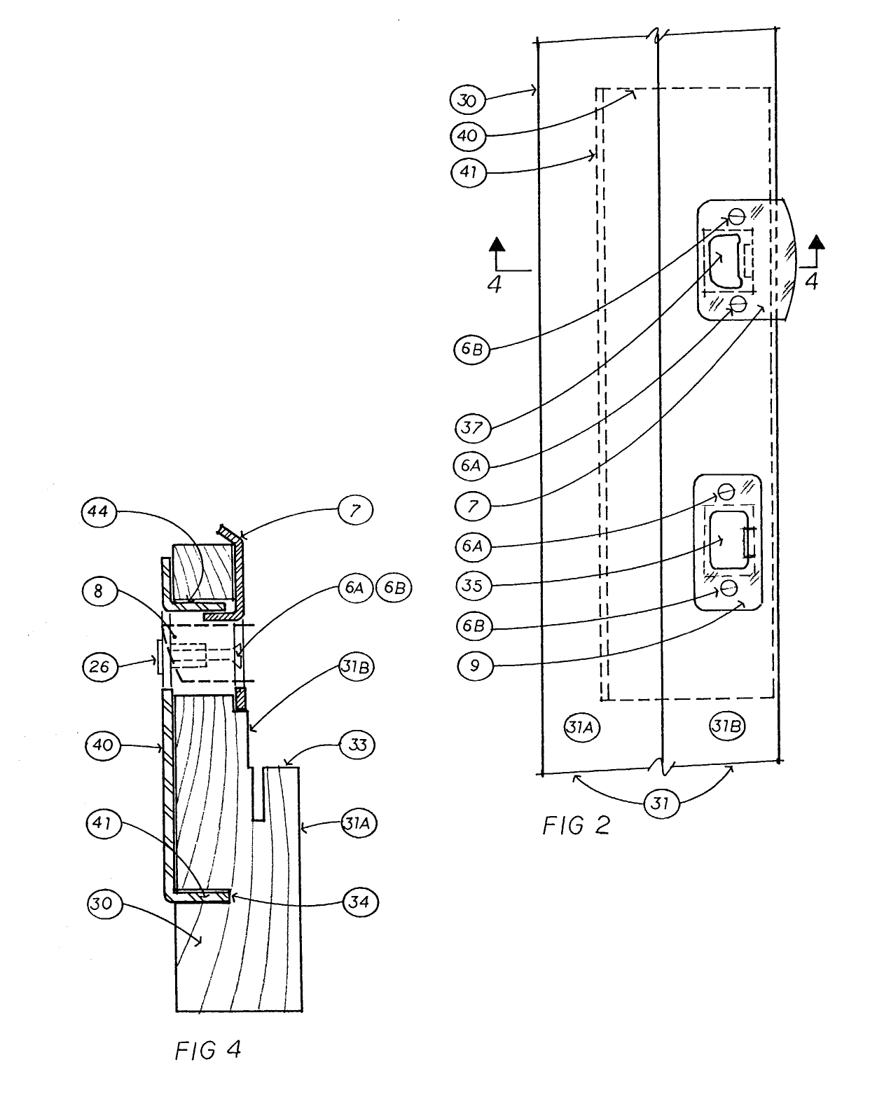

Referring now to the drawing, in which like reference numbers refer to like elements throughout, FIGS. 1 and 3 show a hinge side of a reinforced door jamb according to an exemplary embodiment of the present invention. FIGS. 2 and 4 show a latch hinge side of a reinforced door jamb according to an exemplary embodiment of the present invention. A door jamb 10 and 30, as is known in the art, is reinforced with one or more security plates 20 and 40. A front face 11 and 31 of the door jamb 10 and 30 faces a door opening formed in the frame of a building or structure. Front face 11 and 31 is stepped such that an outer portion 11A and 31A adjacent the outside of the structure extends further into the door opening than an inner portion 11B and 31B adjacent the inside of the structure. A step 13 and 33 (shown in FIGS. 3 and 4) between inner portion 11B and 31B and outer portion 11A and 31A faces the inside of the structure, such that the edge of a door mounted to the door jamb is not exposed to the outside of the structure. A hinge 5 is mounted on the inner portion 11B of the front face 11 of the hinge side of the door jamb.

In an exemplary embodiment of the present invention, the hinge 5 is secured to front face 11B with machine screw fasteners 6A and/or wood screw fasteners 6B. Fasteners 6A secure hinge 5 with their head and engage a threaded fastener 26 (e.g., a riv-nut or the like) integrally connected to a hinge security plate 20. Wood screw fasteners 6B can be used to secure hinge 5 to door jamb 10 in place of or in addition to fasteners 6A. Wood screw fasteners 6B secure hinge 5 by their head and engage hinge security plate 20 by passing through an aperture in hinge security plate 20 and being fastened into a structure frame (not shown).

Hinge security plate 20 comprises an integral lip 21 extending generally perpendicularly from the main body or abutting face of security plate 20. As shown in FIG. 3, lip 21 extends into a groove 14 formed in back face 15 of binge side 10 of the door jamb. In an exemplary embodiment of the present invention, lip 21 is formed by bending hinge security plate 20 through an angle of at least about ninety degrees. Lip 21 provides enhanced shear strength to the door jamb, making it more difficult to force or “kick-in” the door. Accordingly, hinge security plate 20 comprises a material having sufficient strength and thickness to resist being forced, such as 16 guage galvanized steel.

Groove 14 is formed to receive lip 21. The angle between back face 15 and groove 14 should be about the same angle as the angle between the abutting face of hinge hinge plate 20 and lip 21. Groove 14 should have a sufficient width to receive lip 21 but should not have an excessive clearance that would allow the lip to pull out of groove 14. For example, a slot width of between about three thirty-seconds (3/32) and three sixteenths (3/16) inch would facilitate insertion and retention of the lip of a 16 guage plate. The depth of groove 14 and lip 21 should be sufficient to provide substantial engagement without compromising the integrity of the door jamb, for example about one-half (½) inch in a one inch thick door jamb.

In an exemplary embodiment of the present invention, hinge security plate 20 on hinge side 10 extends about the full height of the door opening engaging each of a plurality of hinges 5 attaching a door to the door jamb. Hinge security plate 10 may include a plurality of apertures for receiving fasteners that secure hinge side 10 of the door jamb to the frame of a structure.

As shown in FIGS. 2 and 4, a latch side 30 of the door jamb is configured essentially the same as the hinge side 10. A latch aperture 37 and lock aperture 35 are formed in the latch side 30 of the door jamb to accommodate a door latch 8 and dead-bolt (not shown) extending from a door (not shown). A latch plate 7 and lock plate 9 are fastened to the front face of the latch side 30 of the door jamb in alignment with the latch aperture 37 and lock aperture 35, respectively. Latch plate 7 may be provided with a tab extending into latch aperture 37, as shown in FIG. 4.

As with the hinge side 10, a latch security plate 40 is fastened to the back face of the latch side 30 of the door jamb. Security plate 40 comprises a lip 41 that extends into a groove 34 in the latch side 30 of the door jamb. Latch security plate 40 engages latch plate 7 and lock plate 9 via wood screws 6B passing through apertures in latch security plate 40 and into the frame of a structure, or via threaded fasteners 6A in threaded engagement with threaded fasteners 26 integrally connected to latch security plate 40, or a combination of these methods for engagement. Latch security plate 40 on latch side 30 of the door jamb may have apertures located to align with latch aperture 37 and lock aperture 35 to engage latch 8 and the dead-bolt (not shown).

In an exemplary embodiment of the present invention, latch security plate 40 comprises a latch lip 44 configured and positioned to extend into latch aperture 37. Latch lip 44 provides engagement between latch 8 and latch security plate 40, providing enhanced security, even when the dead-bolt is not engaged, as may occur when the structure is not occupied. A lock lip (not shown) may similarly extend into lock aperture 35 to provide added security.

Although illustrated and described above with reference to certain specific embodiments, the present invention is nevertheless not intended to be limited to the details shown. Rather, various modifications may be made in the details within the scope and range of equivalents of the claims and without departing from the spirit of the invention.

What is claimed:

1. A reinforced door jamb comprising:
a door jamb having a front face configured to face a door opening and a back face opposite the front face; the back face having a groove formed therein; and
a security plate fastened to the back face of the door jamb; the security plate comprising an abutting face abutting the back face of the door jamb and a lip extending into the groove in the door jamb.

2. The reinforced door jamb of claim 1 wherein said lip is formed by bending an edge of the security plate.

3. The reinforced door jamb of claim 1 wherein a lock plate and latch plate are fastened to the front face of the door jamb and the security plate is positioned on the back face of the door jamb opposite the lock plate and latch plate and is fastened to the lock plate and latch plate.

4. The reinforced door jamb of claim 3 wherein the security plate comprises one or more integral threaded fasteners for engagingly receiving threaded fasteners securing the lock plate and latch plate.

5. The reinforced door jamb of claim 3 wherein the security plate comprises a latch lip extending into a latch opening formed in the door jamb.

6. The reinforced door jamb of claim 3 wherein the security plate comprises a lock lip extending into a lock opening formed in the door jamb.

7. The reinforced door jamb of claim 1 wherein a hinge is fastened to the front face of the door jamb and the security plate is positioned on the back face of the door jamb opposite the hinge and is fastened to the hinge.

8. The reinforced door jamb of claim 7 wherein the security plate comprises one or more integral threaded fasteners for engagingly receiving threaded fasteners securing the hinge.

9. A reinforced door jamb with a latch side and a hinge side, the reinforced door jamb comprising:
a door jamb having a front face configured to face a door opening and a back face opposite the front face;
a latch security plate fastened to the back face of the door jamb on the latch side;
a latch plate secured to the front face of the door jamb opposite the security plate on the latch side of the door jamb with two or more fasteners that engage the latch security plate;
a lock plate secured to the front face of the door jamb opposite the security plate on the latch side of the door jamb with a two or more fasteners that engage the latch security plate;
a hinge security plate fastened to the back face of the door jamb on the hinge side; and
a hinge secured to the front face of the door jamb opposite the security plate on the hinge side of the door jamb with a plurality of fasteners that engage the hinge security plate.

10. The reinforced door jamb of claim 9 wherein the back face of the door jamb has a groove formed therein on at least one of a hinge side and a latch side of the door opening.

11. The reinforced door jamb of claim 10 wherein the groove is formed in the latch side of the door jamb and the latch security plate fastened to the back face of the door jamb on the latch side comprises a lip extending into the groove in the door jamb.

12. The reinforced door jamb of claim 10 wherein the groove is formed in the hinge side of the door jamb and the hinge security plate fastened to the back face of the door jamb on the hinge side comprises a lip extending into the groove in the door jamb.

13. The reinforced door jamb of claim 9 wherein at least one of the fasteners securing the latch plate, the lock plate, or the hinge engages the corresponding security plate by extending through an aperture formed therein.

14. The reinforced door jamb of claim 13 wherein the fastener extending through the aperture is threadedly secured in a structure frame.

15. The reinforced door jamb of claim 9 wherein at least one of hinge security plate and latch security plate comprises at least one integral threaded connector and a corresponding fastener is a threaded fastener engaged by the integral threaded connector.
